(19) United States
(12) Patent Application Publication
(10) Pub. No.: US 2026/0126739 A1
(43) Pub. Date: May 7, 2026

(54) IMAGE FORMING APPARATUS

(71) Applicant: KYOCERA Document Solutions Inc., Osaka (JP)

(72) Inventors: Kiyotaka KOBAYASHI, Osaka (JP); Takahisa NAKAUE, Osaka (JP); Ryo TANIGUCHI, Osaka (JP)

(73) Assignee: KYOCERA Document Solutions Inc., Osaka (JP)

(21) Appl. No.: 19/378,963

(22) Filed: Nov. 4, 2025

(30) Foreign Application Priority Data
Nov. 7, 2024 (JP) 2024-194951

(51) Int. Cl. G03G 15/08; G03G 9/113

(52) U.S. Cl. CPC G03G 15/0853; G03G 9/1136; G03G 15/0863; G03G 15/0891; G03G 2215/0607

(57) ABSTRACT

An image forming apparatus includes an image forming portion, a toner container, a control portion, and a storage portion. The control portion corrects, based on an integrated consumption amount of toner from a start of use of a developing device, a target value of a toner concentration in a two-component developer in the developing device. The storage portion stores a first integrated consumption amount that is the integrated consumption amount on a first production line of the image forming apparatus. The control portion calculates a second integrated consumption amount that is the integrated consumption amount in a setup operation for the image forming apparatus and an image output operation performed after a start of use thereof, and uses a sum of the first integrated consumption amount and the second integrated consumption amount to determine a correction value for correcting the target value of the toner concentration.

### INCORPORATION BY REFERENCE

This application is based upon and claims the benefit of priority from the corresponding Japanese Patent Application No. 2024-194951 (filed on Nov. 7, 2024), the entire contents of which are hereby incorporated by reference.

### BACKGROUND

The present disclosure relates to an image forming apparatus, such as a copy machine, a facsimile, or a printer, provided with a developing device that uses a two-component developer composed of a magnetic carrier and toner.

As a developing scheme using dry toner in an image forming apparatus using an electrophotographic process, there is known a two-component developing scheme using a two-component developer that uses a magnetic carrier to charge non-magnetic toner, in which an electrostatic latent image on an image carrying member (a photosensitive member) is developed with a magnetic brush composed of the toner and the carrier and formed on a developing roller.

In a developing device employing the two-component developing scheme, a toner concentration (T/C, a ratio of the toner to the carrier in the developer) in the developing device is detected by a toner concentration sensor, and the developing device is replenished with a fresh supply of toner in an amount compensating for a decrease in toner amount resulting from printing or the like. When, however, an output value of the toner concentration sensor changes for a reason other than a variation in the toner concentration, accurate detection of the toner concentration cannot be achieved, and this may cause an unintended toner replenishing operation to be performed, resulting in an actual measurement value of the toner concentration being higher than an intended toner concentration (a reference concentration).

For example, during a given period in an initial stage of use of the developer, contamination of the carrier by a toner external additive might occur to decrease flowability of the developer. A decrease in the flowability of the developer leads to a decrease in bulk density of the developer, so that the toner concentration sensor outputs an output value higher than an actual value of the toner concentration. As a result, the developing device is not replenished with toner, and thus the toner concentration in the developing device shifts at a level lower than a target value thereof. When the toner concentration shifts at the lower level, a toner charge amount (Q/M) becomes higher than a proper value. At this time, a developing voltage is set to be higher so that a decrease in image density is suppressed, and this has led to a problem that a desired image density is no longer achievable once the developing voltage reaches an upper limit value thereof. In order, therefore, to prevent the toner concentration from shifting at the lower level, a method is conceivable in which carrier contamination is predicted from an integrated printing rate (a toner consumption amount), and based thereon, control is performed so that the toner concentration attains an intended value.

### SUMMARY

An image forming apparatus according to one aspect of the present disclosure includes an image forming portion, a toner container, a control portion, and a storage portion. The image forming portion includes an image carrying member, a charging device, an exposure device, and a developing device. The image carrying member includes a photosensitive layer formed on a surface thereof. The charging device charges the surface of the image carrying member. The exposure device exposes to light the surface of the image carrying member charged by the charging device so as to form an electrostatic latent image thereon. The developing device includes a developing container that contains a two-component developer containing a carrier and toner, a developer carrying member that is rotatably supported in the developing container and carries the two-component developer on a surface thereof, and a toner concentration sensor that detects a toner concentration in the two-component developer in the developing container, and develops the electrostatic latent image into a toner image. The toner container contains the toner with which the developing device is to be replenished. The control portion controls, based on an output value of the toner concentration sensor, replenishment of the developing device with the toner from the toner container and corrects, based on an integrated consumption amount of the toner from a start of use of the developing device, a target value of the toner concentration. The storage portion stores a first integrated consumption amount that is the integrated consumption amount on a first production line of the image forming apparatus. The control portion calculates a second integrated consumption amount that is the integrated consumption amount in a setup operation for the image forming apparatus and an image output operation performed after a start of use thereof, and uses a sum of the first integrated consumption amount and the second integrated consumption amount to determine a correction value for correcting the target value of the toner concentration.

### BRIEF DESCRIPTION OF THE DRAWINGS

FIG. 1 is a schematic view showing an overall configuration of an image forming apparatus according to one embodiment of the present disclosure.

FIG. 2 is a sectional side view of a developing device incorporated in the image forming apparatus according to the embodiment.

FIG. 3 is a partially enlarged view of and around an image forming portion, which includes control paths of the image forming portion.

FIG. 4 is a graph showing a relationship between an integrated printing rate and a correction value for setting a target value of a toner concentration.

FIG. 5 is a graph showing an example of setting the target value of the toner concentration with and without consideration of a toner consumption amount on a production line.

FIG. 6 is a flow chart showing an example of controlling setting the target value of the toner concentration in the image forming apparatus according to the embodiment.

FIG. 7 is a graph showing a conventional example of setting the target value of the toner concentration in which a toner ejection operation is not executed in a spare developing device.

FIG. 8 is a graph showing an example of setting the target value of the toner concentration according to the embodiment in which the toner ejection operation is executed in the spare developing device.

FIG. 9 is a graph showing a relationship between an integrated drive time of a photosensitive drum and a correction amount of a charging voltage.

### DETAILED DESCRIPTION

### 1. Overall Configuration of Image Forming Apparatus

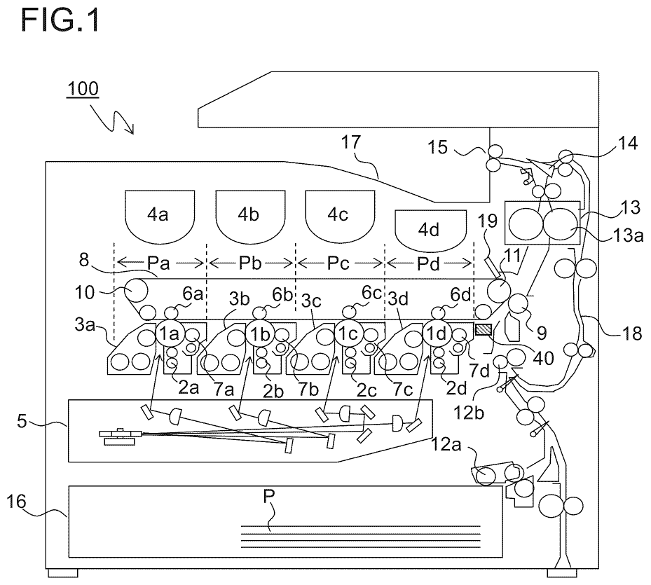

With reference to the appended drawings, the following describes an embodiment of the present disclosure. FIG. 1 is a sectional view showing an internal structure of an image forming apparatus 100 according to one embodiment of the present disclosure. In a main body of the image forming apparatus 100 (herein, a color printer), four image forming portions Pa, Pb, Pc, and Pd are disposed in this order from an upstream side in a conveyance direction (a left side in FIG. 1). The image forming portions Pa to Pd are provided so as to correspond to images of four different colors (cyan, magenta, yellow, and black) and sequentially form the images of cyan, magenta, yellow, and black, respectively, through steps of charging, exposure, development, and transfer.

In the image forming portions Pa to Pd, there are respectively disposed photosensitive drums (image carrying members) 1a, 1b, 1c, and 1d that carry visible images (toner images) of the different colors. As a photosensitive layer, an OPC (an organic photosensitive layer) is stacked on each of surfaces of the photosensitive drums 1a to 1d. Moreover, an intermediate transfer belt 8 that is driven by a drive motor (not shown) to rotate in a counterclockwise direction in FIG. 1 is provided adjacently to the image forming portions Pa to Pd.

Toner images formed respectively on the photosensitive drums 1a to 1d are sequentially and primarily transferred onto the intermediate transfer belt 8 moving in contact with the photosensitive drums 1a to 1d so as to be superimposed on each other. After that, by a secondary transfer roller 9, the toner images thus primarily transferred onto the intermediate transfer belt 8 are secondarily transferred onto a transfer sheet P as one example of a recording medium. Moreover, the transfer sheet P onto which the toner images have been secondarily transferred is, after the toner images are fixed thereto at a fixing portion 13, discharged from the main body of the image forming apparatus 100. An image forming process with respect to each of the photosensitive drums 1a to 1d is executed while the photosensitive drums 1a to 1d are rotated in a clockwise direction in FIG. 1.

The transfer sheet P onto which toner images are to be secondarily transferred is housed in a sheet cassette 16 arranged at a bottom in the main body of the image forming apparatus 100. The transfer sheet P is conveyed to a nip between the secondary transfer roller 9 and a driving roller 11 of the intermediate transfer belt 8 via a paper feed roller 12a and a registration roller pair 12b. A non-seamed (seamless) belt formed of a dielectric resin sheet is primarily used as the intermediate transfer belt 8. Furthermore, a blade-shaped belt cleaner 19 for removing residual toner or the like remaining on a surface of the intermediate transfer belt 8 is arranged on a downstream side of the secondary transfer roller 9.

Next, a description is given of the image forming portions Pa to Pd. Around and below the photosensitive drums 1a to 1d rotatably disposed, there are provided charging devices 2a, 2b, 2c, and 2d that charge the photosensitive drums 1a to 1d, respectively, an exposure device 5 that performs exposure based on image information with respect to the photosensitive drums 1a to 1d, developing devices 3a, 3b, 3c, and 3d that form toner images on the photosensitive drums 1a to 1d, respectively, and cleaning devices 7a, 7b, 7c, and 7d that remove a residual developer (toner) or the like remaining on the photosensitive drums 1a to 1d, respectively.

Upon an input of image data from a host apparatus such as a personal computer, first, the charging devices 2a to 2d uniformly charge the surfaces of the photosensitive drums 1a to 1d, respectively. Then, the exposure device 5 applies light thereto in accordance with the image data so that electrostatic latent images corresponding to the image data are formed on the photosensitive drums 1a to 1d.

Each of the developing devices 3a to 3d is filled with a prescribed amount of a two-component developer containing toner of a corresponding one of the different colors of cyan, magenta, yellow, and black. When, through after-mentioned formation of toner images, a ratio of the toner in the two-component developer filled in any of the developing devices 3a to 3d falls below a preset value, the any of the developing devices 3a to 3d is replenished with toner from a corresponding one of toner containers 4a to 4d. The toner in the developer is supplied onto the photosensitive drums 1a to 1d by the developing devices 3a to 3d, respectively, and is electrostatically deposited thereon. Thus, there are formed toner images corresponding to the electrostatic latent images formed by exposure to light from the exposure device 5.

Further, primary transfer rollers 6a to 6d apply an electric field of a prescribed transfer voltage between themselves and the photosensitive drums 1a to 1d, respectively, and thus the toner images of cyan, magenta, yellow, and black formed respectively on the photosensitive drums 1a to 1d are primarily transferred onto the intermediate transfer belt 8. These images of the four colors are formed in a prescribed positional relationship that is predetermined for formation of a prescribed full-color image. After that, in preparation for subsequent formation of new electrostatic latent images, residual toner or the like remaining on the surfaces of the photosensitive drums 1a to 1d after primary transfer is removed by the cleaning devices 7a to 7d, respectively.

The intermediate transfer belt 8 is stretched between a driven roller 10 on an upstream side and the driving roller 11 on a downstream side. As the driving roller 11 is driven to rotate by the drive motor (not shown), the intermediate transfer belt 8 starts to rotate in the counterclockwise direction, and thus the transfer sheet P is conveyed at prescribed timing from the registration roller pair 12b to the nip (a secondary transfer nip) between the driving roller 11 and the secondary transfer roller 9 provided adjacently to the driving roller 11. While the transfer sheet P passes through the secondary transfer nip, the toner images on the intermediate transfer belt 8 are secondarily transferred onto the transfer sheet P. The transfer sheet P onto which the toner images have been secondarily transferred is conveyed to the fixing portion 13.

The transfer sheet P conveyed to the fixing portion 13 is heated and pressed by a fixing roller pair 13a so that the toner images are fixed to a surface of the transfer sheet P, and thus the prescribed full-color image is formed thereon. A conveyance direction of the transfer sheet P on which the full-color image has been formed is switched by a branch portion 14 branching into a plurality of directions, and thus the transfer sheet P is directly (or after being sent to a double-sided conveyance path 18 and thus subjected to double-sided printing) discharged onto a discharge tray 17 by a discharge roller pair 15.

On a downstream side of the image forming portion Pd, an image density sensor 40 is arranged at a position opposite to the intermediate transfer belt 8. As the image density sensor 40, an optical sensor is typically used that includes a light-emitting element formed of an LED or the like and a light-receiving element formed of a photodiode or the like. To measure an amount of toner deposited on the intermediate transfer belt 8, measurement light is applied from the light-emitting element to reference images formed on the intermediate transfer belt 8 and then becomes incident on the light-receiving element as light reflected by the toner and light reflected by the belt surface.

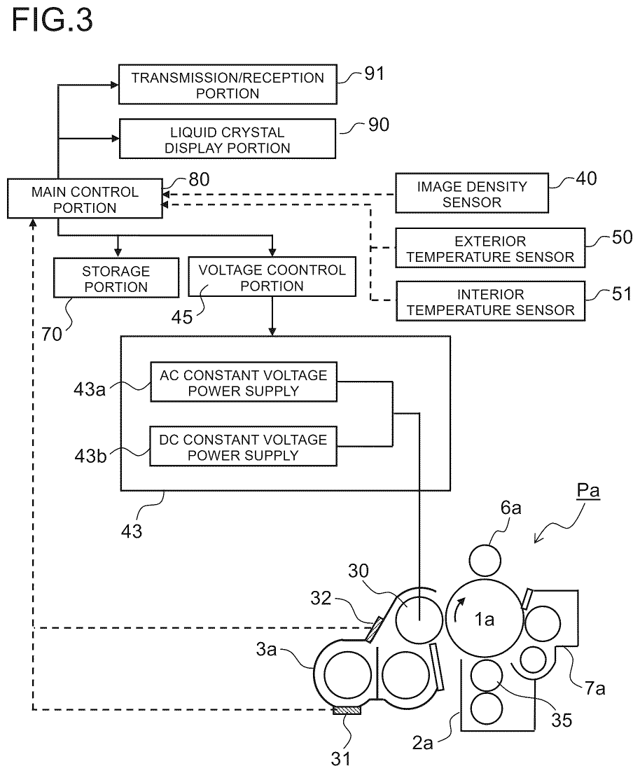

The lights reflected from the toner and the belt surface each include a specular reflection light component and a diffused reflection light component. The specular and diffused reflection light components are split with a polarization splitting prism and then become incident on separate light-receiving elements. The light-receiving elements perform photoelectric conversion on the received specular and diffused reflection light components and output signals to a main control portion 80 (see FIG. 3). Further, a toner amount is detected from a change in characteristics of the output signals related to the specular and diffused reflection light components, and based on a comparison thereof with a predetermined reference density, a characteristic value or the like of a developing voltage is adjusted so that density correction (calibration) is performed for each of the different colors.

### 2. Configuration of Developing Device

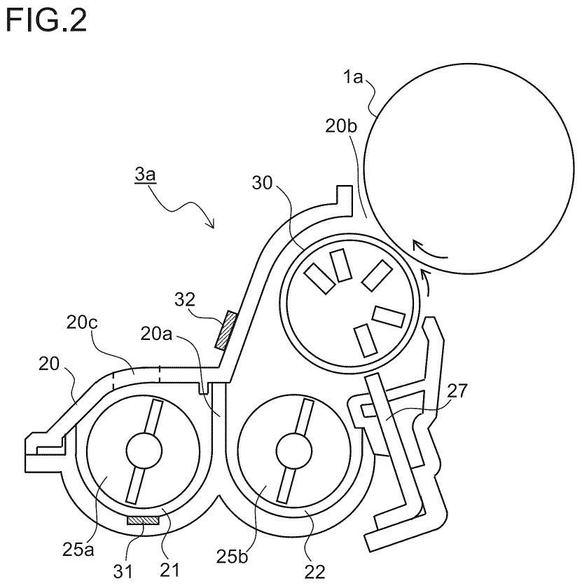

FIG. 2 is a sectional side view of the developing device 3a incorporated in the image forming apparatus 100 according to the embodiment. While the following exemplarily describes the developing device 3a arranged in the image forming portion Pa in FIG. 1, the developing devices 3b to 3d arranged in the image forming portions Pb to Pd, respectively, are also basically similar in configuration to the developing device 3a and thus are omitted from the description.

As shown in FIG. 2, the developing device 3a includes a developing container 20 for storing a two-component developer (hereinafter, may also be referred to simply as a developer) containing a magnetic carrier and toner. The developing container 20 is partitioned by a partition wall 20a into a stirring conveyance chamber 21 and a supply conveyance chamber 22. In the stirring conveyance chamber 21 and the supply conveyance chamber 22, there are respectively and rotatably disposed a stirring conveyance screw 25a and a supply conveyance screw 25b for mixing and stirring toner supplied from the toner container 4a (see FIG. 1) with the magnetic carrier so that the toner is charged.

Further, by the stirring conveyance screw 25a and the supply conveyance screw 25b, the developer is, while being stirred, conveyed in an axis direction (a direction perpendicular to a drawing plane of FIG. 2) and circulates between the stirring conveyance chamber 21 and the supply conveyance chamber 22 via unshown developer passages formed at both ends of the partition wall 20a. That is, in the developing container 20, a developer circulation path is formed by the stirring conveyance chamber 21, the supply conveyance chamber 22, and the developer passages.

The developing container 20 extends to a diagonally upper right side in FIG. 2, and in the developing container 20, a developing roller 30 is arranged on a diagonally upper right side of the supply conveyance screw 25b. A part of an outer circumferential surface of the developing roller 30 is exposed through an opening 20b of the developing container 20 and opposed to the photosensitive drum 1a. The developing roller 30 rotates in a counterclockwise direction in FIG. 2.

The developing roller 30 is composed of a cylindrical developing sleeve that rotates in the counterclockwise direction in FIG. 2 and a magnet (not shown) with a plurality of magnetic poles secured inside the developing sleeve. While the developing sleeve used herein has a knurled surface, it is also possible to use a developing sleeve having a surface with a multitude of concaves (dimples) formed therein, a developing sleeve having a blasted surface, a developing sleeve processed by blasting in addition to knurling and concave formation, and a developing sleeve processed by plating.

Furthermore, the developing container 20 includes a regulation blade 27 mounted along a longitudinal direction of the developing roller 30 (the direction perpendicular to the drawing plane of FIG. 2). A slight gap is formed between a distal end of the regulation blade 27 and a surface of the developing roller 30.

By a high voltage generation circuit 43 (see FIG. 3), a developing voltage composed of a DC voltage Vslv (DC) and an AC voltage Vslv (AC) is applied to the developing roller 30.

On a bottom surface of the stirring conveyance chamber 21, a toner concentration sensor 31 is arranged to face the stirring conveyance screw 25a. The toner concentration sensor 31 is to detect a ratio of the toner to the carrier in the developer (T/C) and is formed of, for example, a magnetic permeability sensor that detects a magnetic permeability of the developer in the developing container 20. Upon detecting the magnetic permeability of the developer, the toner concentration sensor 31 outputs a voltage value corresponding to a detection result to the after-mentioned main control portion 80 (see FIG. 3), and based on an output value of the toner concentration sensor 31, the main control portion 80 determines a toner concentration.

Such a sensor output value changes in accordance with the toner concentration. That is, as the toner concentration increases, a percentage of the toner to the carrier increases, and an increased ratio of the toner, which is not magnetically conductive, results in a lower output value. On the other hand, as the toner concentration decreases, the percentage of the toner to the carrier decreases, and an increased ratio of the carrier, which is magnetically conductive, results in a higher output value. In accordance with the toner concentration thus determined, the main control portion 80 transmits a control signal to a toner replenishment motor (not shown) so that the stirring conveyance chamber 21 is replenished with a prescribed amount of toner from the toner container 4a (see FIG. 1) via a toner replenishment port 20c.

An IC tag 32 is attached to an outer side surface of the developing container 20. The IC tag 32 stores information related to a toner consumption amount (an integrated printing rate) in a case where a toner ejection operation and an image output operation are performed during production of the image forming apparatus 100 or the developing device 3a. The information stored in the IC tag 32 is read by a reader/writer module (not shown) in the main body of the image forming apparatus 100 and is transmitted to the main control portion 80 (see FIG. 3).

### 3. Control Paths of Image Forming Portion

FIG. 3 is a partially enlarged view of and around the image forming portion Pa, which includes control paths of the image forming portion Pa. While the following describes a configuration and the control paths of the image forming portion Pa, the image forming portions Pb to Pd are also similar in configuration and control paths to the image forming portion Pa and thus are omitted from the description.

The developing roller 30 is connected to the high voltage generation circuit 43 that generates an oscillating voltage in which a DC voltage and an AC voltage are superimposed on each other. The high voltage generation circuit 43 includes an AC constant voltage power supply 43a and a DC constant voltage power supply 43b. The AC constant voltage power supply 43a outputs a sinusoidal AC voltage generated from a low-voltage DC voltage modulated in a pulse shape using a step-up transformer (not shown). The DC constant voltage power supply 43b outputs a DC voltage obtained by rectifying a sinusoidal AC voltage generated from a low-voltage DC voltage modulated in a pulse shape using the step-up transformer.

During image formation, the high voltage generation circuit 43 outputs, from each of the AC constant voltage power supply 43a and the DC constant voltage power supply 43b, a developing voltage obtained by superimposing an AC voltage on a DC voltage.

Next, with reference to FIG. 3, a description is given of a control system for the image forming apparatus 100. In the image forming apparatus 100, there is provided the main control portion 80 formed of a CPU or the like. The main control portion 80 is connected to a storage portion 70 composed of a ROM, a RAM, and so on. Based on control programs or control data stored in the storage portion 70, the main control portion 80 controls various portions (the charging devices 2a to 2d, the exposure device 5, the developing devices 3a to 3d, the primary transfer rollers 6a to 6d, the cleaning devices 7a to 7d, the fixing portion 13, the high voltage generation circuit 43, a voltage control portion 45, and so on) in the image forming apparatus 100.

The voltage control portion 45 controls the high voltage generation circuit 43. The voltage control portion 45 may be constituted by the control programs stored in the storage portion 70. An exterior temperature sensor 50 is to detect a temperature outside the image forming apparatus 100 and is installed at, for example, a location near an air intake duct (not shown) on a lateral side of the sheet cassette 16 in FIG. 1, where an influence of heat generating portions is less likely to be exerted. An interior temperature sensor 51 is to detect a temperature inside the image forming apparatus 100, particularly, a temperature at and around the developing devices 3a to 3d and is arranged in a vicinity of the image forming portions Pa to Pd.

A liquid crystal display portion 90 and a transmission/reception portion 91 are connected to the main control portion 80. The liquid crystal display portion 90 functions as a touch panel for a user to perform various settings for the image forming apparatus 100 and displays a status of the image forming apparatus 100, an image forming situation, the number of printed sheets, and so on. The transmission/reception portion 91 performs external communication over a telephone network or the Internet.

### 4. Setting, Using Integrated Printing Rate, of Target Value of Toner Concentration in Developing Device

As described earlier, there is the problem that contamination of a carrier by a toner external additive might occur to decrease flowability of a developer. Particularly, in a case of using a silicone-coated carrier having a surface coated with a silicone resin, during a given period in an initial stage of use of the developer, contamination of the carrier surface by a toner external additive might occur to decrease flowability imparted by silicone coating.

A decrease in flowability of the developer leads to a decrease in bulk density of the developer, so that the toner concentration sensor 31 outputs an output value higher than an actual value of a toner concentration. As a result, the developing devices 3a to 3d are not replenished with toner from the toner containers 4a to 4d, respectively, and thus the toner concentration in the developing devices 3a to 3d shifts at a level lower than a target value thereof.

As a solution thereto, in the present disclosure, based on a toner consumption amount from a start of use of the developing devices 3a to 3d, carrier contamination is predicted, and based thereon, control is performed so that the toner concentration attains the target value. Specifically, based on an integrated printing rate from the start of use of the developing devices 3a to 3d, a correction value for setting the target value of the toner concentration is determined.

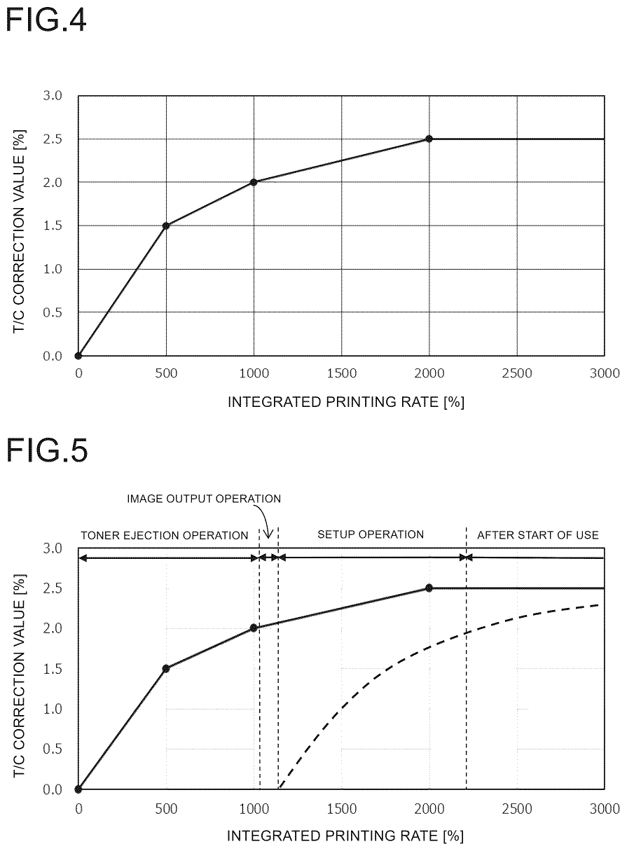

FIG. 4 is a graph showing a relationship between the integrated printing rate and the correction value for setting the target value of the toner concentration. As shown in FIG. 4, the correction value for setting the target value of the toner concentration increases with increasing integrated printing rate from the start of use of the developing devices 3a to 3d. For example, in a case where the target value of the toner concentration is 6.5%, at an integrated printing rate of 500%, the correction value is 1.5%, and thus the target value of the toner concentration needs to be corrected to 6.5%+1.5%=8%. At an integrated printing rate of 1000%, the correction value is 2%, and thus the target value of the toner concentration needs to be corrected to 6.5%+2%=8.5%. At an integrated printing rate of not less than 2000%, the correction value becomes constant (2.5%), and thus the target value of the toner concentration is corrected to 6.5%+2.5%=9%.

The relationship between the integrated printing rate and the correction value shown in FIG. 4 is used to correct the target value of the toner concentration, and thus it is possible to suppress a decrease in toner concentration attributable to a decrease in flowability of the developer caused by carrier contamination.

Meanwhile, on a production line (a first production line) of the image forming apparatus 100, there are executed a toner ejection operation of ejecting toner from the developing devices 3a to 3d and an image output operation. The toner ejection operation is performed for supplying the toner to an area of contact between each of the photosensitive drums 1a to 1d and a cleaning blade (not shown) of a corresponding one of the cleaning devices 7a to 7d. This reduces friction between the each of the photosensitive drums 1a to 1d and the cleaning blade and thus facilitates rotation of the photosensitive drums 1a to 1d. The image output operation is performed for making adjustments to the image forming apparatus 100 as a whole, such as a density adjustment or a positional adjustment of toner images of the different colors.

Conventionally, a toner consumption amount (an integrated printing rate) on the production line is reset at the time of shipment of the image forming apparatus 100. This has been a reason why no consideration is given to the toner consumption amount (the integrated printing rate) on the production line at the time of setup of the image forming apparatus 100 after arrival at a user.

FIG. 5 is a graph showing an example of setting the target value of the toner concentration with and without consideration of the toner consumption amount on the production line. In a case where consideration is given to the toner consumption amount on the production line (a solid line in FIG. 5), an integrated printing rate at completion of the setup (at a start of use) is determined as an integrated printing rate on the production line (the toner ejection operation+the image output operation=1100%)+an integrated printing rate in a setup operation (1100%)=2200%. At the integrated printing rate of 2200%, the correction value is 2.5%, and thus in a case where the target value of the toner concentration is 6.5%, the target value of the toner concentration is corrected to 6.5%+2.5%=9%.

In a case where no consideration is given to the toner consumption amount on the production line (a broken line in FIG. 5), an integrated printing rate at the completion of the setup (at the start of use) is determined by an integrated printing rate in the setup operation (1100%) alone. At the integrated printing rate of 1100%, the correction value is about 2%, and thus in the case where the target value of the toner concentration is 6.5%, the target value of the toner concentration is corrected to 6.5%+2%=8.5%. That is, the target value of the toner concentration is set to be lower than in the case where consideration is given to the toner consumption amount on the production line (9%), and this leads to a decrease in image density.

In the image forming apparatus 100 according to the embodiment, an integrated printing rate in the toner ejection operation and the image output operation on the production line (a first integrated consumption amount Σpn1) is stored in advance in the IC tag 32, and the first integrated consumption amount Σpn1 is not reset at the time of the setup of the image forming apparatus 100.

Further, after completion of the setup operation and the start of use of the image forming apparatus 100, an integrated printing rate in the setup operation and an image output operation performed after the start of use (a second integrated consumption amount Σpn2) is calculated. Based on a sum of the first integrated consumption amount Σpn1 and the second integrated consumption amount Σpn2, the main control portion 80 determines the correction value, thus setting the target value of the toner concentration.

In the example shown in FIG. 5, an integrated consumption amount (an integrated printing rate) obtained by adding a toner consumption amount in the setup operation to the toner consumption amount on the production line (the first integrated consumption amount Σpn1) is not less than 2000%. At the integrated printing rate of not less than 2000%, the correction value becomes constant (2.5%), and thus after the start of use of the image forming apparatus 100, it is no longer required to correct the target value of the toner concentration. In a case where the integrated consumption amount (the integrated printing rate) obtained by adding the toner consumption amount in the setup operation to the first integrated consumption amount Σpn1 is less than 2000%, based on an integrated consumption amount obtained by further adding thereto a toner consumption amount in an image forming operation performed after the start of use of the image forming apparatus 100 (the second integrated consumption amount Σpn2), the target value of the toner concentration is corrected.

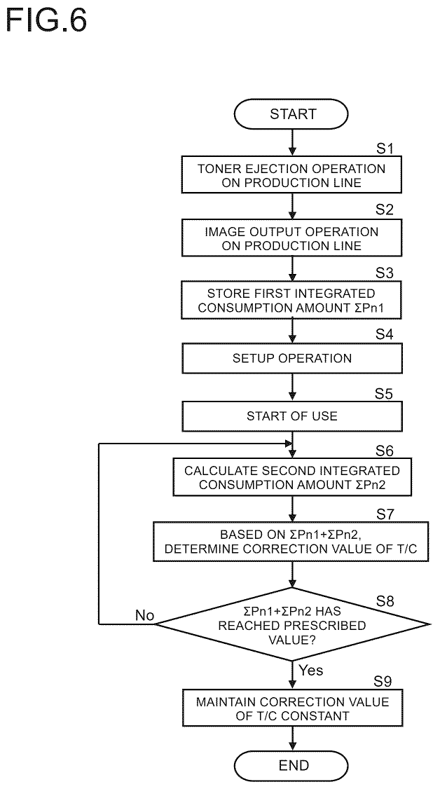

FIG. 6 is a flow chart showing an example of controlling setting the target value of the toner concentration in the image forming apparatus 100 according to the embodiment. With reference to FIG. 1 to FIG. 5 as necessary, by following steps shown in FIG. 6, a description is given of a procedure for setting the target value of the toner concentration based on the integrated printing rate.

First, on the production line of the image forming apparatus 100, the toner ejection operation of ejecting the toner from the developing devices 3a to 3d is executed (step S1). Next, the image output operation is executed (step S2). Further, the first integrated consumption amount Σpn1, which is a toner consumption amount in the toner ejection operation and the image output operation, is stored in the IC tag 32 of each of the developing devices 3a to 3d (step S3).

After that, the image forming apparatus 100 is shipped from a factory, and the setup operation for the image forming apparatus 100 is executed at an installation location thereof (step S4). After completion of the setup operation, the image forming apparatus 100 is started to be used (step S5). The main control portion 80 calculates the second integrated consumption amount Σpn2, which is a toner consumption amount in the setup operation and the image output operation performed after the start of use (step S6).

As shown in FIG. 5, based on a sum Σpn1+Σpn2 of the first integrated consumption amount Σpn1 stored in the IC tag 32 at step S3 and the second integrated consumption amount Σpn2 calculated at step S6, the main control portion 80 determines a correction value for setting a target value of a toner concentration (T/C) (step S7).

Next, the main control portion 80 determines whether or not Σpn1+Σpn2 has reached a prescribed value (for example, 2000%) (step S8). In a case where Σpn1+Σpn2 has not reached the prescribed value (No at Step S8), a return is made to step S6 so that calculation of the second integrated consumption amount Σpn2 and determination of the correction value based on Σpn1+Σpn2 are continuously performed (steps S6 and S7).

In a case where Σpn1+Σpn2 has reached the prescribed value (Yes at step S8), the correction value is maintained constant (for example, at 2.5%) (step S9), and control of setting the target value of the toner concentration is completed.

According to the above-described control, the target value of the toner concentration is set with consideration given to the toner consumption amount on the production line of the image forming apparatus 100. Thus, it is possible to accurately predict an increase in output value of the toner concentration sensor 31 caused by carrier contamination and thus to maintain the toner concentration in the developing devices 3a to 3d constant. As a result, it is possible to suppress a decrease in image density in an initial stage of use of the image forming apparatus 100.

While in the above-described control, the integrated consumption amount (the first integrated consumption amount Σpn1 and the second integrated consumption amount Σpn2) of the toner is calculated using the integrated printing rate, other methods can also be used to calculate the integrated consumption amount of the toner. The other methods include a method in which the integrated consumption amount of the toner is calculated based on a dot count obtained when an electrostatic latent image is formed by the exposure device 5 or an amount of toner supplied from each of the toner containers 4a to 4d to a corresponding one of the developing devices 3a to 3d.

Furthermore, while in the above-described control, the integrated consumption amount (the first integrated consumption amount Σpn1 and the second integrated consumption amount Σpn2) of the toner is stored in the IC tag 32 mounted to each of the developing devices 3a to 3d, the integrated consumption amount of the toner can also be stored in the storage portion 70 (see FIG. 3) in the main body of the image forming apparatus 100. In a case, however, where any of the developing devices 3a to 3d has been replaced, the integrated consumption amount stored in the storage portion 70 no longer agrees with an actual value of the integrated consumption amount. It is, therefore, required that a mechanism for detecting whether or not any of the developing devices 3a to 3d has been replaced be provided and that, in a case where the any of the developing devices 3a to 3d has been replaced, control be performed so that the integrated consumption amount stored in the storage portion 70 is updated.

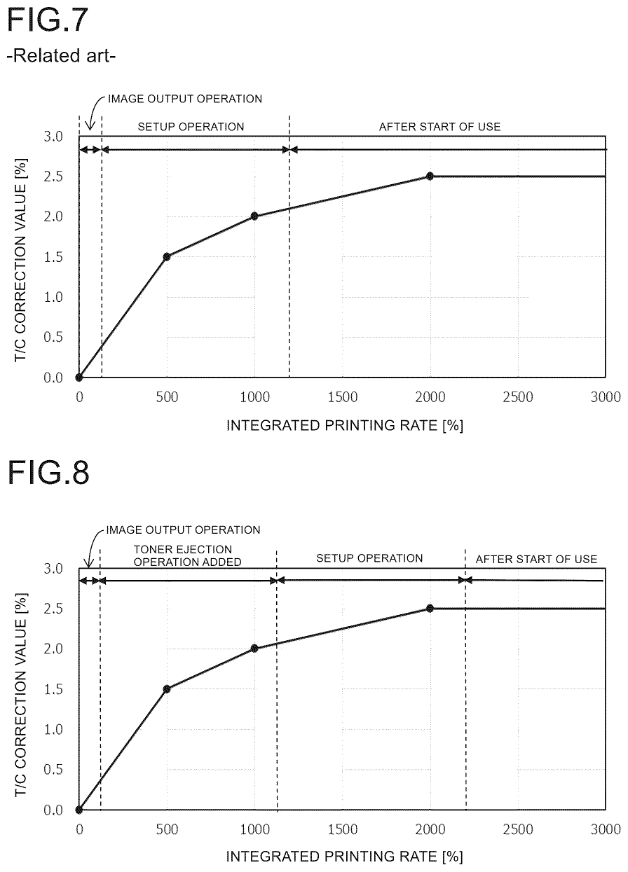

Next, a description is given of spare (replacement) developing devices 3a to 3d (replacement developing devices) produced on a production line (a second production line) separate from that of the main body of the image forming apparatus 100. FIG. 7 is a graph showing a conventional example of setting the target value of the toner concentration in which the toner ejection operation is not executed in each of the spare developing devices 3a to 3d. As shown in FIG. 7, on the production line of the spare developing devices 3a to 3d, the toner ejection operation is not performed, and only the image output operation is performed. That is, the spare developing devices 3a to 3d are different in terms of the first integrated consumption amount Σpn1 from the original developing devices 3a to 3d (see FIG. 5) that have already been mounted in the main body of the image forming apparatus 100.

For example, in a case where only the developing device 3a among the developing devices 3a to 3d has been replaced, for the developing devices 3b to 3d, the sum of the first integrated consumption amount Σpn1 and the second integrated consumption amount Σpn2 is more than the prescribed value, and thus the target value of the toner concentration is set to a higher value. In the example shown in FIG. 5, at the integrated printing rate of not less than 2000%, the target value of the toner concentration is set to 9%.

On the other hand, the developing device 3a having replaced the original developing device 3a has not gone through the toner ejection operation, and thus when this developing device 3a is mounted in the main body of the image forming apparatus 100, the sum of the first integrated consumption amount Σpn1 and the second integrated consumption amount Σpn2 has not reached the prescribed value (the integrated printing rate of 2000%). As a result, when the target value of the toner concentration is set to 9% as in a case of the developing devices 3b to 3d, the toner concentration becomes too high, causing a decrease in toner charge amount.

FIG. 8 is a graph showing an example of setting the target value of the toner concentration according to the embodiment in which the toner ejection operation is executed in each of the spare developing devices 3a to 3d. According to the embodiment, the spare developing devices 3a to 3d are also subjected to the toner ejection operation after being mounted in the image forming apparatus 100 and thus are adjusted to be equal in toner consumption amount to the original developing devices 3a to 3d that have already been mounted. Similarly to the original developing devices 3a to 3d that have already been mounted in the main body of the image forming apparatus 100, the integrated printing rate on the production line (the first integrated consumption amount Σpn1) stored in the IC tag 32 mounted to each of the spare developing devices 3a to 3d is not reset at the time of shipment of these developing devices 3a to 3d.

Thus, the spare developing devices 3a to 3d can be set so that, when they are mounted in the image forming apparatus 100, at a start of the setup operation, a toner consumption amount thereof agrees with that of the original developing devices 3a to 3d that have already been mounted in the main body of the image forming apparatus 100. Accordingly, regardless of whether the developing devices 3a to 3d are replaced, in all the developing devices 3a to 3d, the same correction value (2.5% in FIG. 8) can be used to set the same target value of the toner concentration (9% in FIG. 8), and thus correction control of the toner concentration can be simplified.

### 5. Setting of Target Value of Charging Voltage Using Integrated Drive Time of Photosensitive Drum

To maintain image quality, it is required to properly control a surface potential V0 of each of the photosensitive drums 1a to 1d. To control the surface potential V0, it is required to determine a correction amount of a charging voltage Vdc to be applied to a charging roller 35 (see FIG. 3) in each of the charging devices 2a to 2d.

In the image forming apparatus 100 according to the embodiment, similarly to the toner consumption amount (the integrated printing rate) of each of the developing devices 3a to 3d, factors for determining the correction amount of the charging voltage Vdc, such as an application time of the charging voltage Vdc, an integrated number of rotations (an integrated drive time) of each of the photosensitive drums 1a to 1d, and so on are not reset at the time of shipment of the image forming apparatus 100.

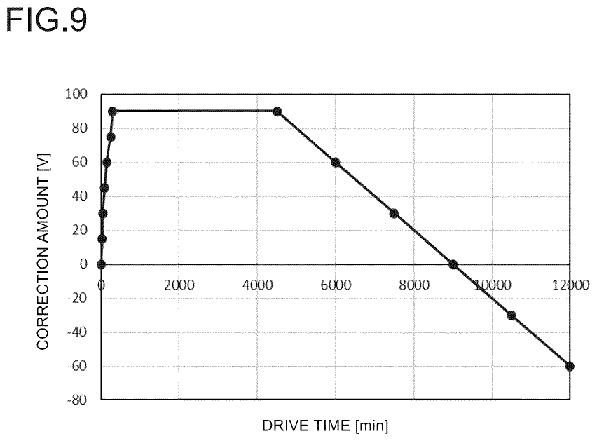

FIG. 9 is a graph showing a relationship between the integrated drive time of each of the photosensitive drums 1a to 1d and the correction amount of the charging voltage Vdc. As shown in FIG. 9, the correction amount of the charging voltage Vdc is not constant with respect to the drive time but changes largely at an initial stage of use when a thickness of the organic photosensitive layer of each of the photosensitive drums 1a to 1d changes largely.

With this in view, the integrated drive time or an integrated drive distance on the production line (a first integrated drive amount) of each of the photosensitive drums 1a to 1d is stored in advance in the storage portion 70 (see FIG. 3) and, without being reset at the time of shipment, is combined with an integrated drive time or an integrated drive distance during the setup operation and after a start of image formation (a second integrated drive amount), and based on a resulting sum, the correction amount is determined. Thus, it is possible to properly control the surface potential V0 at the initial stage of use of the image forming apparatus 100 and thus to suppress a decrease in image quality.

In addition, the present disclosure is not limited to the foregoing embodiment and can be variously modified without departing from the spirit of the disclosure. For example, while the foregoing embodiment has described the image forming apparatus 100 including the developing devices 3a to 3d of a two-component developing type each provided with the developing roller (a developer carrying member) 30 that carries a two-component developer, the present disclosure is not limited thereto. The present disclosure is quite similarly applicable to an image forming apparatus including a developing device having a configuration in which a developer carrying member such as a magnetic roller is further provided between the supply conveyance screw 25b and the developing roller 30, and after a developer is supplied from the supply conveyance screw 25b to the magnetic roller, only toner is supplied from the magnetic roller to the developing roller 30.

Furthermore, while the foregoing embodiment has described the image forming apparatus 100 by use of a color printer shown in FIG. 1 as an example thereof, without being limited to a color printer, the present disclosure is applicable also to an image forming apparatus including a developing device of the two-component developing type, such as a color copy machine, a color multifunctional peripheral, a monochrome printer, a monochrome copy machine, or a monochrome multifunctional peripheral.

The present disclosure is usable in an image forming apparatus including a developing device that uses a two-component developer. Through the use of the present disclosure, it is possible to provide an image forming apparatus capable of suppressing a decrease in image density attributable to carrier contamination at a start of use of the image forming apparatus.

What is claimed is:

1. An image forming apparatus, comprising:
an image forming portion including:
an image carrying member that includes a photosensitive layer formed on a surface thereof;
a charging device that charges the surface of the image carrying member;
an exposure device that exposes to light the surface of the image carrying member charged by the charging device so as to form an electrostatic latent image thereon; and
a developing device including:
a developing container that contains a two-component developer containing a carrier and toner;
a developer carrying member that is rotatably supported in the developing container and carries the two-component developer on a surface thereof; and
a toner concentration sensor that detects a toner concentration in the two-component developer in the developing container,
the developing device being configured to develop the electrostatic latent image into a toner image;
a toner container that contains the toner with which the developing device is to be replenished; and
a control portion that controls, based on an output value of the toner concentration sensor, replenishment of the developing device with the toner from the toner container and corrects, based on an integrated consumption amount of the toner from a start of use of the developing device, a target value of the toner concentration,
a storage portion that stores a first integrated consumption amount that is the integrated consumption amount on a first production line of the image forming apparatus,
wherein
the control portion calculates a second integrated consumption amount that is the integrated consumption amount in a setup operation for the image forming apparatus and an image output operation performed after a start of use thereof, and uses a sum of the first integrated consumption amount and the second integrated consumption amount to determine a correction value for correcting the target value of the toner concentration.

1. The image forming apparatus according to claim 1, wherein
the first integrated consumption amount is an integrated value of a printing rate in a toner ejection operation of ejecting the toner from the developing device and the image output operation on the first production line.

3. The image forming apparatus according to claim 2, wherein
the developing device comprises a replacement developing device produced on a second production line separate from the first production line,
the storage portion is mounted to the replacement developing device and is capable of storing the integrated consumption amount of the toner on the second production line, and
the replacement developing device has not been subjected to the toner ejection operation on the second production line, and the control portion performs control in which the replacement developing device is subjected to the toner ejection operation after being incorporated in the image forming apparatus so that the first integrated consumption amount of the replacement developing device agrees with that of the developing device that has already been mounted in the image forming apparatus.

4. The image forming apparatus according to claim 1, wherein
the target value of the toner concentration becomes constant when the integrated consumption amount reaches a prescribed value, and
the integrated consumption amount obtained by adding a toner consumption amount in the setup operation to the first integrated consumption amount is not less than the prescribed value.

5. The image forming apparatus according to claim 1, wherein
the carrier has a surface coated with a silicone resin.

6. The image forming apparatus according to claim 1, wherein
the image carrying member includes, as the photosensitive layer, an organic photosensitive layer formed thereon,
based on an integrated drive time or an integrated drive distance from a start of use of the image carrying member, the control portion corrects a charging voltage to be applied to the charging device,
the storage portion stores a first integrated drive amount that is the integrated drive time or the integrated drive distance on the first production line, and
the control portion calculates a second integrated drive amount that is the integrated drive time or the integrated drive distance in the setup operation and the image output operation and uses a sum of the first integrated drive amount and the second integrated drive amount to determine a correction amount of the charging voltage to be applied to the charging device.
